(19) United States
(12) Patent Application Publication
(10) Pub. No.: US 2026/0231080 A1
(43) Pub. Date: Aug. 6, 2026

(54) METHODS, SYSTEMS, AND COMPUTER READABLE MEDIA FOR DELEGATED NETWORK SLICE ADMISSION CONTROL USING A SERVICE COMMUNICATION PROXY (SCP)

(71) Applicant: Oracle International Corporation, Redwood Shores, CA (US)

(72) Inventors: Virendra Singh, Bangalore (IN); Shashikiran Bhalachandra Mahalank, Bangalore (IN); Jay Rajput, Bangalore (IN)

(21) Appl. No.: 19/635,386

(22) Filed: Mar. 31, 2026

(51) Int. Cl. H04W 60/04; H04W 48/18; H04W 76/10

(52) U.S. Cl. CPC H04W 60/04; H04W 48/18; H04W 76/10

(57) ABSTRACT

A method for delegated network slice admission control using an SCP includes receiving, by the SCP and from an NF, a message relating to registration of a UE or establishment of a PDU session. The method further includes performing, by the SCP, delegated network slice admission control by: sending, by the SCP, a request message to an NSACF to perform a network slice availability check and update procedure; and receiving, by the SCP and from the NSACF, a response message indicating results of the network slice availability check and update procedure. The method further includes performing, by the SCP and based on the response indicating results of the network slice availability check and update procedure, signaling relating to the registration of the UE or the establishment of the PDU session.

### TECHNICAL FIELD

The subject matter described herein relates to network slice admission control. More particularly, the subject matter described herein relates to methods, systems, and computer readable media for delegated network slice admission control using an SCP.

### BACKGROUND

In 5G telecommunications networks, a network function that provides service is referred to as a producer network function (NF) or NF service producer. A network function that consumes services is referred to as a consumer NF or NF service consumer. A network function can be a producer NF, a consumer NF, or both, depending on whether the network function is consuming, producing, or consuming and producing services. The terms “producer NF” and “NF service producer” are used interchangeably herein. Similarly, the terms “consumer NF” and “NF service consumer” are used interchangeably herein.

A given producer NF may have many service endpoints, where a service endpoint is the point of contact for one or more NF instances hosted by the producer NF. The service endpoint is identified by a combination of Internet protocol (IP) address and port number or a fully qualified domain name (FQDN) that resolves to an IP address and port number on a network node that hosts a producer NF. An NF service instance is an instance of a producer NF that provides a service. A given producer NF instance may include more than one NF service instance if the producer NF instance provides multiple services. It should also be noted that multiple producer NF instances can share the same service endpoint.

NFs register with an NF repository function (NRF). The NRF maintains profiles of available NF instances identifying the services supported by each NF instance. The profile of an NF instance is referred to in Third Generation Partnership Project (3GPP) Technical Specification (TS) TS 29.510 as an NF profile. NF instances can obtain information about other NF instances that have registered with the NRF through the NF discovery service operation. According to the NF discovery service operation, a consumer NF sends an NF discovery request to the NRF. The NF discovery request includes query parameters that the NRF uses to locate the NF profiles of producer NFs capable of providing the service identified by the query parameters. NF profiles are data structures that define the type of service provided by an NF instance as well as contact and capacity information regarding the NF instance.

A service communication proxy (SCP) can also invoke the NF discovery service operation to learn about available producer NF instances. The case where the SCP uses the NF discovery service operation to obtain information about producer NF instances on behalf of consumer NFs is referred to as delegated discovery. Consumer NFs connect to the SCP, and the SCP load balances traffic among producer NF service instances that provide the required services or directly routes the traffic to the destination producer NF instances.

One problem that can occur in 5G and other types of networks is the burden on consumer NFs of implementing the interface required to communicate with a network slice admission control function (NSACF). Another related problem is the message latency caused by the number of message hops when each consumer NF implements the interface for communicating with the NSACF.

The NSACF was introduced in Release 17 of Third Generation Partnership Project (3GPP) Technical Specification (TS) 23.501 and 23.502 to support network slice admission control functions required to avoid network slice overload. Implementing network slice admission control requires upgrades of Release 15/16(R15/R16) network functions, such as the access and mobility management function (AMF) and session management function (SMF), to support the Nnsacf interface. In addition, there is additional SBI message latency during UE registration/deregistration and packet data unit (PDU) session establishment/release procedures with additional message hops for indirect SBI communication.

Accordingly, in light of these and other difficulties, there exists a need for more efficient communication with the NSACF during UE registration and PDU session establishment procedures.

### SUMMARY

A method for delegated network slice admission control using an SCP includes receiving, by the SCP and from an NF, a message relating to registration of a UE or establishment of a PDU session. The method further includes performing, by the SCP, delegated network slice admission control by sending, by the SCP, a request message to an NSACF to perform a network slice availability check and update procedure; and receiving, by the SCP and from the NSACF, a response message indicating results of the network slice availability check and update procedure. The method further includes performing, by the SCP and based on the response indicating results of the network slice availability check and update procedure, signaling relating to the registration of the UE or the establishment of the PDU session.

According to another aspect of the subject matter described herein, receiving the message relating to the registration of the UE or establishment of the PDU session includes receiving an Nudm_UECM_Registration_Response message from a unified data management function (UDM) and directed towards an access and mobility management function (AMF) and further comprising, holding, by the SCP, the Nudm_UECM_Registration_Response message while the SCP performs the delegated network slice admission control.

According to another aspect of the subject matter described herein, sending the request message to the NSACF includes sending, by the SCP, an Nnsacf_NSAC_NumOfUEsUpdate_Request message to the NSACF.

According to another aspect of the subject matter described herein, receiving the response message from the NSACF includes receiving, from the NSACF, an Nnsacf_NSAC_NumOfUEsUpdate_Response message including a result indication per network slice selection availability information (NSSAI) as to whether a maximum number of UEs has been reached for a network slice identified by the NSSAI.

According to another aspect of the subject matter described herein, the method for delegated network slice admission control includes adding, by the SCP, the result indications per NSSAI to the Nudm_UECM_Registration_Response message and wherein performing, by the SCP and based on the response indicating results of the network slice availability check and update procedure, signaling relating to the registration of the UE or the establishment of the PDU session includes forwarding, by the SCP and to the AMF, the Nudm_UECM_Registration response message including the result indications per NSSAI.

According to another aspect of the subject matter described herein, receiving the message relating to registration of the UE or establishment of the PDU session includes receiving an Nsmf_PDUSession_CreateSMContext request message from an access and mobility management function (AMF). According to another aspect of the subject matter described herein, sending the request message to the NSACF includes sending, by the SCP, an Nnsacf_NSAC_NumOfPDUsUpdate_Request message to the NSACF.

According to another aspect of the subject matter described herein, receiving the response message from the NSACF includes receiving, from the NSACF, an Nnsacf_NSAC_NumOfPDUsUpdate_Response message including a result indication per network slice selection availability information (NSSAI) as to whether a maximum number of PDU sessions has been reached for a network slice identified by the NSSAI.

According to another aspect of the subject matter described herein, the method for delegated network slice admission control includes performing, by the SCP and based on the response indicating results of the network slice availability check and update procedure, signaling relating to the registration of the UE or the establishment of the PDU session includes sending the Nsmf_PDUSession_CreateSMContext request message to a session management function (SMF); and including, in the Nsmf_PDUSession_CreateSMContext request message, NSSAIs of network slices to which admission is granted by the NSACF.

According to another aspect of the subject matter described herein, the method for delegated network slice admission control includes receiving, by the SCP and from the SMF, a Nsmf_PDUSession_CreateSMContext response message and forwarding the Nsmf_PDUSession_CreateSMContext response message to the AMF.

According to another aspect of the subject matter described herein, a system for delegated network slice admission control using an SCP is provided. The system includes an SCP including at least one processor and a memory. The system further includes a delegated network slice admission controller implemented by the at least one processor for: receiving, from an NF, a message relating to registration of a UE or establishment of a PDU session; performing delegated network slice admission control by: sending a request message to an NSACF to perform a network slice availability check and update procedure; and receiving, from the NSACF, a response message indicating results of the network slice availability check and update procedure; and performing, based on the response indicating results of the network slice availability check and update procedure, signaling relating to the registration of the UE or the establishment of the PDU session.

According to another aspect of the subject matter described herein, the message relating to registration of the UE or establishment of the PDU session includes an Nudm_UECM_Registration_Response message from a unified data management function (UDM) and directed towards an access and mobility management function (AMF) and wherein the delegated network slice admission controller is configured to hold the Nudm_UECM_Registration_Response message while the SCP performs the delegated network slice admission control.

According to another aspect of the subject matter described herein, the request message sent to the NSACF comprises an Nnsacf_NSAC_NumOfUEsUpdate_Request message.

According to another aspect of the subject matter described herein, the response message received from the NSACF comprises an Nnsacf_NSAC_NumOfUEsUpdate_Response message including a result indication per network slice selection availability information (NSSAI) as to whether a maximum number of UEs has been reached for a network slice identified by the NSSAI.

According to another aspect of the subject matter described herein, the delegated network slice admission controller is configured to add the result indications per NSSAI to the Nudm_UECM_Registration_Response message and to perform the signaling relating to the registration of the UE or the establishment of the PDU session by forwarding, to the AMF, the Nudm_UECM_Registration response message including the result indications per NSSAI.

According to another aspect of the subject matter described herein, the message relating to registration of a UE or establishment of a PDU session includes an Nsmf_PDUSession_CreateSMContext request message from an access and mobility management function (AMF).

According to another aspect of the subject matter described herein, the request message sent to the NSACF includes an Nnsacf_NSAC_NumOfPDUsUpdate_Request message.

According to another aspect of the subject matter described herein, the response message received from the NSACF includes an Nnsacf_NSAC_NumOfPDUsUpdate_Response message including a result indication per network slice selection availability information (NSSAI) as to whether a maximum number of PDU sessions has been reached for a network slice identified by the NSSAI.

According to another aspect of the subject matter described herein, the delegated network slice admission controller is configured to perform the signaling relating to the registration of the UE or the establishment of the PDU session by: sending the Nsmf_PDUSession_CreateSMContext request message to a session management function (SMF); including, in the Nsmf_PDUSession_CreateSMContext request message, NSSAIs of network slices to which admission is granted by the NSACF; and receiving, by the SCP and from the SMF, a Nsmf_PDUSession_CreateSMContext response message and forwarding the Nsmf_PDUSession_CreateSMContext response message to the AMF.

According to another aspect of the subject matter described herein, a non-transitory computer readable medium having stored thereon executable instructions that when executed by a processor of a computer control the computer to perform steps is provided. The steps include receiving, by an SCP and from an NF, a message relating to registration of a UE or establishment of a PDU session. The steps further include performing, by the SCP, delegated network slice admission control by: sending, by the SCP, a request message to an NSACF to perform a network slice availability check and update procedure. The method further includes receiving, by the SCP and from the NSACF, a response message indicating results of the network slice availability check and update procedure. The method further includes performing, by the SCP and based on the response indicating results of the network slice availability check and update procedure, signaling relating to the registration of the UE or the establishment of the PDU session.

The subject matter described herein can be implemented in software in combination with hardware and/or firmware. For example, the subject matter described herein can be implemented in software executed by a processor. In one exemplary implementation, the subject matter described herein can be implemented using a non-transitory computer readable medium having stored thereon computer executable instructions that when executed by the processor of a computer control the computer to perform steps. Exemplary computer readable media suitable for implementing the subject matter described herein include non-transitory computer-readable media, such as disk memory devices, chip memory devices, programmable logic devices, and application specific integrated circuits. In addition, a computer readable medium that implements the subject matter described herein may be located on a single device or computing platform or may be distributed across multiple devices or computing platforms.

### BRIEF DESCRIPTION OF THE DRAWINGS

Exemplary implementations of the subject matter described herein will now be explained with reference to the accompanying drawings, of which:

FIG. 1 is a network diagram illustrating an exemplary 5G system network architecture;

FIG. 2 is a message flow diagram illustrating exemplary messages exchanged between the AMF and the NSACF for checking and updating the number of available UEs per network slice in response to a UE registration request;

FIG. 3 is a message flow diagram illustrating exemplary messages exchanged between the SMF and the NSACF for checking and updating the number of available PDU sessions per network slice in response to a PDU session establishment request;

FIG. 4 is a message flow diagram illustrating exemplary messages exchanged for a UE registration without delegated network slice admission control;

FIG. 5 is a message flow diagram illustrating exemplary messages exchanged for PDU session establishment without delegated network slice admission control;

FIG. 6 is a message flow diagram illustrating exemplary messages exchanged for UE registration with delegated network slice admission control by an SCP;

FIG. 7 is a message flow diagram illustrating exemplary messages exchanged for PDU session establishment with delegated network slice admission control by an SCP;

FIG. 8 is a block diagram illustrating an exemplary SCP for performing delegated network slice admission control for UE registration and PDU session establishment procedures; and

FIG. 9 is a flow chart illustrating an exemplary process for delegated network slice admission control by an SCP for UE registration and PDU session establishment procedures.

### DETAILED DESCRIPTION

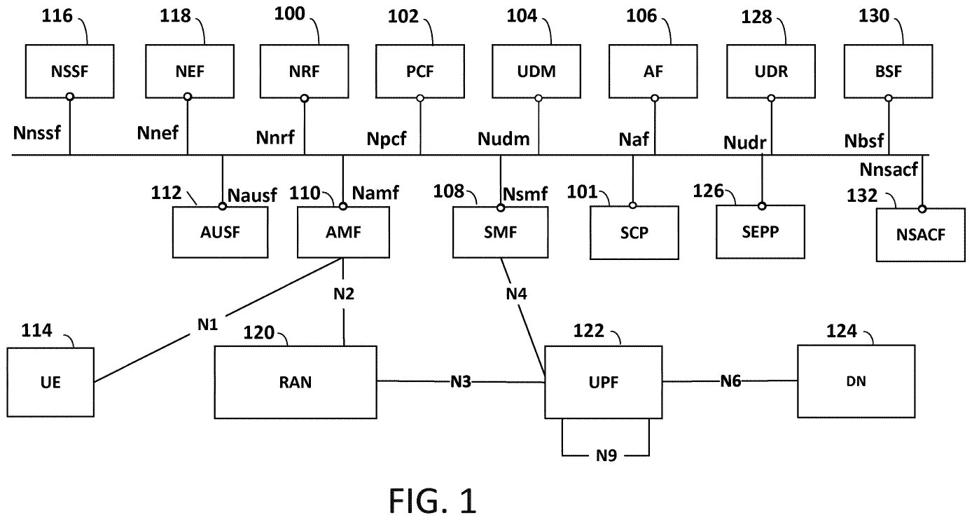

FIG. 1 is a block diagram illustrating an exemplary 5G system network architecture. The architecture in FIG. 1 includes NRF 100 and SCP 101, which may be located in the same home public land mobile network (HPLMN). As described above, NRF 100 may maintain profiles of available NF instances and their supported services and allow consumer NFs or SCPs to subscribe to and be notified of the registration of new/updated NF instances. SCP 101 may also support service discovery and selection of NF instances. SCP 101 may perform load balancing of connections between consumer and producer NFs.

NRF 100 is a repository for profiles of NF instances. To communicate with a producer NF instance, a consumer NF or an SCP must obtain the NF profile of the producer NF instance from NRF 100. The NF profile is a JavaScript object notation (JSON) data structure defined in 3GPP TS 29.510. The NF profile includes attributes that indicate the type of service provided, capacity of the NF instance, and information for contacting the NF instance.

In FIG. 1, any of the network functions can be consumer NFs, producer NFs, or both, depending on whether they are requesting, providing, or requesting and providing services. In the illustrated example, the NFs include a PCF 102 that performs policy related operations in a network, a unified data management function (UDM) 104 that manages user data, and an application function (AF) 106 that provides application services.

The NFs illustrated in FIG. 1 further include an SMF 108 that manages sessions between an AMF 110 and PCF 102. AMF 110 performs mobility management operations similar to those performed by a mobility management entity (MME) in 4G networks. An authentication server function (AUSF) 112 performs authentication services for user equipment (UEs), such as user equipment (UE) 114, seeking access to the network.

A network slice selection function (NSSF) 116 provides network slicing services for devices seeking to access specific network capabilities and characteristics associated with a network slice. NSSF 116 provides the NSSelection service, which allows NFs to request information about network slices and the NSSAIReachability service, which enables NFs to update and subscribe to receive notification of updates in network slice selection assistance information (NSSAI) reachability information.

A network exposure function (NEF) 118 provides application programming interfaces (APIs) for application functions seeking to obtain information about Internet of things (IoT) devices and other UEs attached to the network. NEF 118 performs similar functions to the service capability exposure function (SCEF) in 4G networks.

A radio access network (RAN) 120 connects user equipment (UE) 114 to the network via a wireless link. Radio access network 120 may be accessed using a gNB (not shown in FIG. 1) or other wireless access point. A user plane function (UPF) 122 can support various proxy functionality for user plane services. One example of such proxy functionality is multipath transmission control protocol (MPTCP) proxy functionality. UPF 122 may also support performance measurement functionality, which may be used by UE 114 to obtain network performance measurements. Also illustrated in FIG. 1 is a data network (DN) 124 through which UEs access data network services, such as Internet services.

SEPP 126 filters incoming traffic from another PLMN and performs topology hiding for traffic exiting the home PLMN. SEPP 126 may communicate with a SEPP in a foreign PLMN which manages security for the foreign PLMN. Thus, traffic between NFs in different PLMNs may traverse two SEPP functions, one for the home PLMN and the other for the foreign PLMN. A UDR 128 stores subscription data for UEs. A binding support function (BSF) 130 manages bindings between PDU sessions and PCFs. NSACF 132 performs network slices admission control functions to ensure that network slices are not overburdened by UEs or PDU sessions.

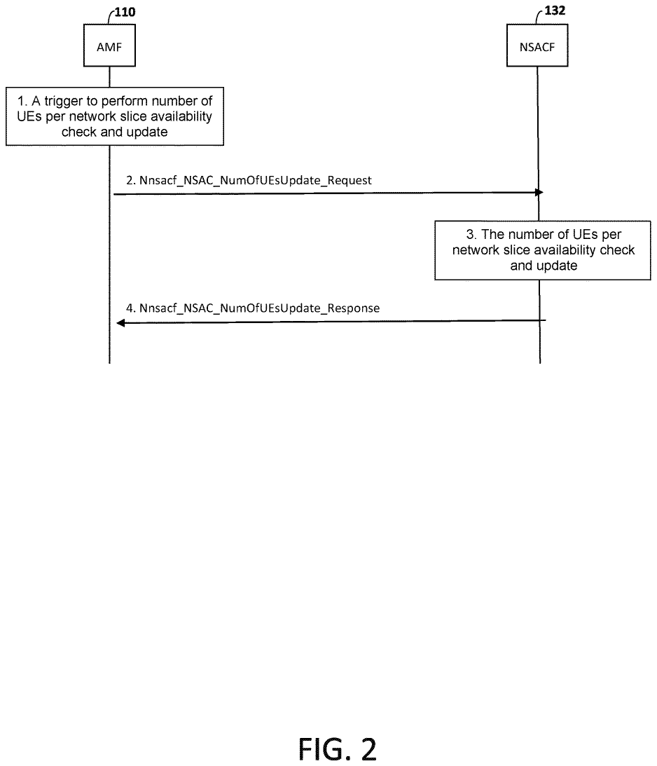

As stated above, one problem that may occur in 5G and other types of networks is the implementation burden and message latency caused by implementing the NSACF communication interfaces at each consumer NF. FIG. 2 is a message flow diagram illustrating exemplary messages exchanged between the AMF and the NSACF for checking and updating the number of available UEs per network slice in response to a UE registration request. Referring to FIG. 2, in step 1, AMF 110 detects a trigger to perform a number of UEs per network slice availability check and update procedure. In one example, the trigger may be a UE registration request. In step 2, AMF 110 sends an Nnsacf_NSAC_NumOfUEsUpdate_Request message to NSACF 132. In step 3, NSACF 132 determines whether the maximum number of UEs per network slice has been reached for each network slice identified in the Nnsacf_NSAC_NumOfUEsUpdate_Request message, and, if the maximum number of UEs has not been reached, increments the number of UEs per network slice. In step 4, NSACF 132 generates and sends an Nnsacf_NSAC_NumOfUEsUpdate_Response message including a result indication per network slice indicating whether or not the maximum number of UEs has been reached.

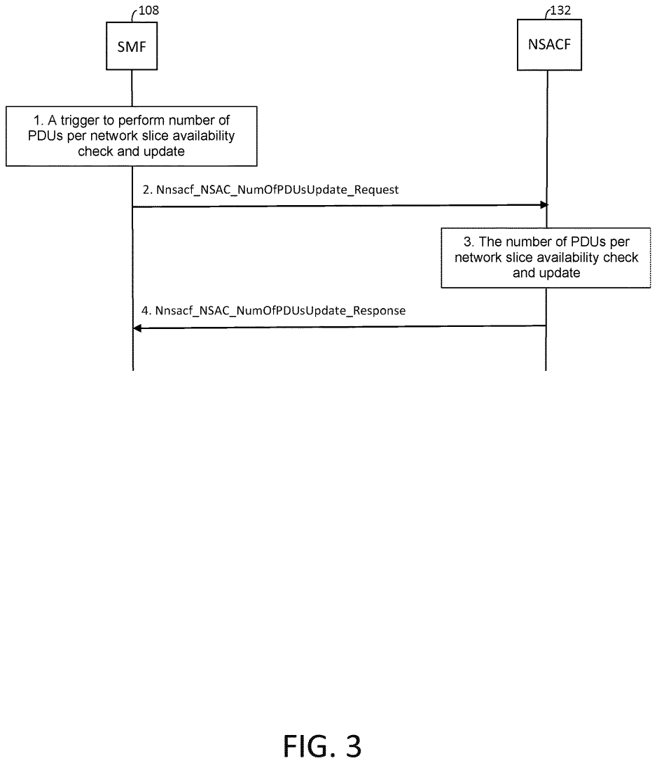

FIG. 3 is a message flow diagram illustrating exemplary messages exchanged between the SMF and the NSACF for checking and updating the number of available PDU sessions per network slice in response to a PDU session establishment request. Referring to FIG. 3, in step 1, AMF 110 detects a trigger to perform a number of PDU sessions per network slice availability check and update procedure. In one example, the trigger may be a PDU session establishment request. In step 2, SMF 108 anchoring the session sends an Nnsacf_NSAC_NumOfPDUsUpdate_Request message to NSACF 132. In step 3, NSACF 132 determines whether the maximum number of PDU sessions per network slice has been reached for each network slice identified in the Nnsacf_NSAC_NumOfPDUsUpdate_Request message, and, if the maximum number of PDU sessions for a network slice has not been reached, and the request includes an increment flag, increments the number of PDU sessions per network slice. In step 4, NSACF 132 generates and sends an Nnsacf_NSAC_NumOfPDUsUpdate_Response message including a result indication per network slice indicating whether or not the maximum number of PDU sessions has been reached.

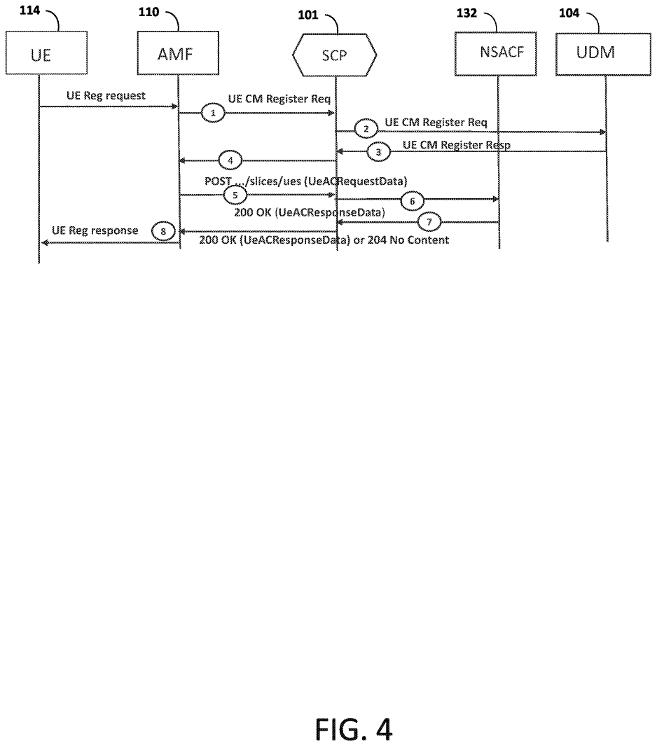

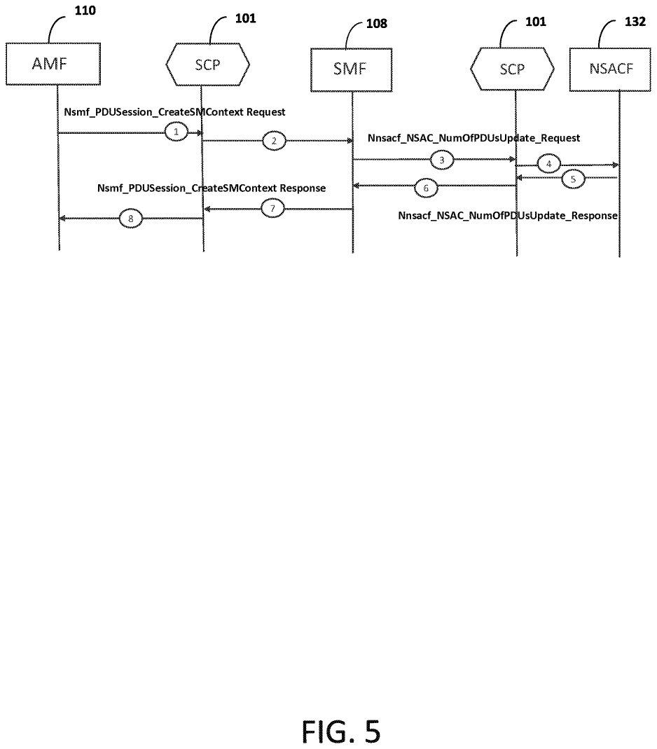

As demonstrated by FIGS. 2 and 3, support for network slice admission control functionality requires a 5G core network upgrade with the deployment of NSACF network function instances. The NSACF was introduced in Release 17 of 3GPP specifications and hence requires an upgrade of the pre-Release-17 versions of the AMF, SMF, and other NFs to support an NSACF interface implementation compliant with Release 17 and subsequent releases. In addition, as will be demonstrated by the message flows in FIGS. 4 and 5, implementing the NSACF interfaces on the AMF and SMF results in additional SBI message latency for UE registration/deregistration and PDU session establishment procedures with additional service operations to be performed at AMF and SMF, respectively.

FIG. 4 is a message flow diagram illustrating exemplary messages exchanged for a UE registration without delegated network slice admission control. Referring to FIG. 4, when a UE sends a UE registration request message to AMF 110, in step 1, AMF 110 sends an Nudm_UECM_Registration request message to SCP 101. In step 2, SCP 101 routes the Nudm_UECM_Registration request message to UDM 104. In step 3, UDM 104 generates and sends an Nudm_UECM_Registration response message to SCP 101. The Nudm_UECM_Registration response message identifies network slices that the UE is allowed to access. In step 4, SCP 101 routes the Nudm_UECM_Registration response message to AMF 110.

In the example illustrated in FIG. 4, it is assumed that AMF 110 implements the interface for communicating with NSACF 132. Accordingly, in step 5, AMF 110 generates and sends an Nnsacf_NSAC_NumOfUEsUpdate_Request message to NSACF 132 via SCP 101 to request and update the number of UEs per network slice that UE 114 is allowed to use. In step 6, SCP 101 forwards the Nnsacf_NSAC_NumOfUEsUpdate_Request message to NSACF 132. In step 7, NSACF 132 responds with a Nnsacf_NSAC_NumOfUEsUpdate_Response message including a result indication per network slice indicating whether or not the maximum number of UEs has been reached. In step 8, SCP 101 forwards the Nnsacf_NSAC_NumOfUEsUpdate_Response message to AMF 110. AMF 110 sends a UE registration response to UE 114. It can be seen from the message flow illustrated in FIG. 4 that eight core network message hops are required for a UE registration with network slice admission control when AMF implements the Nnsacf interface for communicating with NSACF 132.

FIG. 5 is a message flow diagram illustrating exemplary messages exchanged for PDU session establishment without delegated network slice admission control. Referring to FIG. 5, in step 1, AMF 110 sends an Nsmf_PDUSession_CreateSMContext request message to SCP 101. In step 2, SCP 101 forwards the request to SMF 108. In step 3, the Nsmf_PDUSession_CreateSMContext request message triggers SMF 108 to send an Nnsacf_NSAC_NumOfPDUsUpdate_Request to NSACF 132 via SCP 101. In step 4, SCP 101 forwards the request to NSACF 132.

NSACF 132 updates the number of PDUs per network slice identified in the request message and responds in step 5 by generating and sending an Nnsacf_NSAC_NumOfPDUsUpdate_Response message to SMF 108 via SCP 101. In step 6, SCP 101 forwards the response message to SMF 108. In step 7, SMF 108 generates and sends an Nsmf_PDUSession_CreateSMContext response message to AMF 110 via SCP 101. In step 8, SCP 101 sends the Nsmf_PDUSession_CreateSMContext response to AMF 110. From the message flow in FIG. 5, it can be seen that 8 message hops are required to perform PDU session establishment when network slice admission control communication functionality is implemented on the SMF.

To address the aforementioned issues with implementing network slice admission control communication functionality on the consumer NFs, the subject matter described herein provides for delegated network slice admission control for the UE CM registration and PDU session establishment procedures. The SCP implements delegated network slice admission control functionality and tracks: the maximum number of UEs per network slice during UE CM (de)registration procedure; and the maximum number of PDU sessions per network slice during PDU session establishment/release procedures.

The NSACF controls the number of UEs per network slice by incrementing/decrementing the UE count per network slice during UE registration/de-registration procedure. Upon receiving UE CM registration response from the UDM, the SCP initiates the delegated network slice admission control by generating and sending the Nnsacf_NSAC_NumOfUEsUpdate_Request towards the NSACF using the UE and network slice identification information from 3gpp-Sbi-Correlation-Info header received in the Nudm_UECM_Registration request message from the AMF. The SCP may have a configurable option to perform delegated slice admission control. SCP holds the Nudm_UECM_Registration response to the AMF and waits for response from NSACF regarding slice admission control.

The NSACF performs the check to determine if the UE count exceeds the configured allowed max UE threshold for a given network slice and responds back with error or success response. Upon receiving the Nnsacf_NSAC_NumOfUEsUpdate_Response from the NSACF, the SCP resumes processing of the UECM registration transaction by sending the UECM response to the AMF. The SCP adds identifiers of the admitted slices to the 3gpp-Sbi-Correlation-Info header as received in UeACResponseData from the NSACF and includes the updated 3gpp-Sbi-Correlation-Info header in UECM registration response transmitted by the SCP to the AMF.

The 3gpp-Sbi-Correlation-Info header may be used to contain correlation information (e.g., UE identity), that may be used by an operator in various offline network management, performance analysis and troubleshooting tools/applications to identify messages (requests, responses, subscriptions, notifications) related to a particular subscriber. The header contains correlation information, e.g., the UE identifier related to the HTTP request or response. The encoding of the header follows the Augmented Backus-Naur Form (ABNF) as defined in Internet Engineering Task Force (IETF) Request for Comments (RFC) 9110. The following is an example of contents of the 3gpp-Sbi-Correlation-Info header:

$$Sbi - Correlation - Info - Header = {}^{‶} 3 gpp - Sbi - Correlation - Info {:}^{″} OWS correlationinfo * ( {}^{‶} {;}^{″} OWS correlationinfo ) OWS correlationinfo = cytpe {}^{‶} {-}^{″} cvalue ctype = {}^{‶} {imsi}^{″} / {}^{‶} {impi}^{″} / {}^{‶} {suci}^{″} / {}^{‶} {nai}^{″} / {}^{‶} {gci}^{″} / {}^{‶} {gli}^{″} / {}^{‶} {impu}^{″} / {}^{‶} {msisdn}^{″} / {}^{‶} {extid}^{″} / {}^{‶} {imei}^{″} / {}^{‶} {imeisv}^{″} / {}^{‶} {mac}^{″} / {}^{‶} {eui}^{″} / extention - token extension - token = 1 * ( {{}^{‶} {!}^{″} / {}^{‶} {\#}^{″} / {}^{‶} {\$}^{″} / {}^{‶} {\%}^{″} / {}^{‶} \&}^{″} / {}^{‵‵‵‵‵} / {}^{‶} {*}^{″} / {}^{‶} {+}^{″} / {}^{‶} {.}^{″} / {{{}^{‶}}^{∧}}^{″} / {}^{‶} {\_}^{″} / {{{}^{‶}}^{‵}}^{″} / {}^{‶} {\vert}^{″} / {}^{‶} {\sim}^{″} / DIGIT / ALPHA ) cvalue = 1 * ( tchar / {}^{‶} {@}^{″} )$$

The subject matter described herein uses the 3gpp-Sbi-Correlation-Info header to carry the UE identifier (SUPI in imsi ctype) along with network slice information in the extension-token ctype across all SBI messages relating to the UE registration procedure.

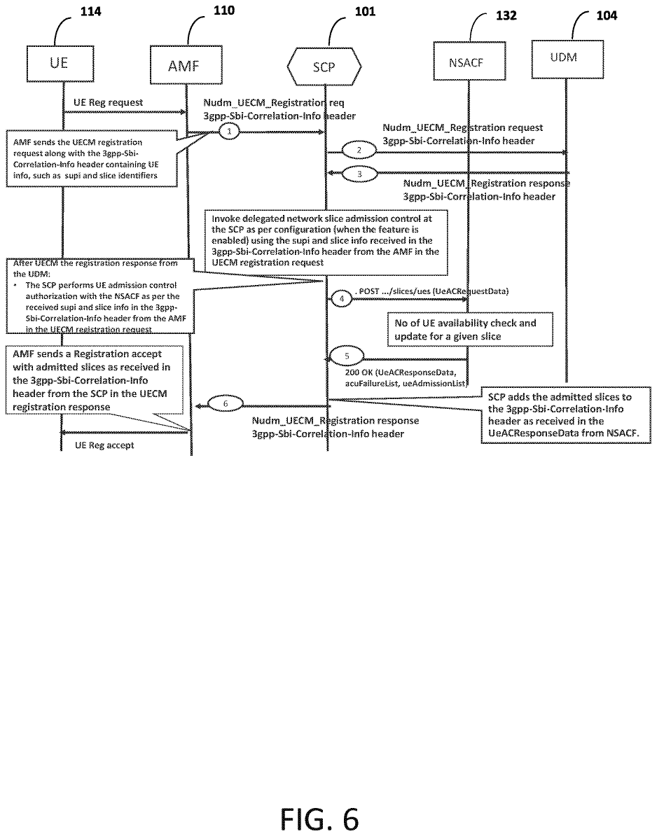

FIG. 6 is a message flow diagram illustrating exemplary messages exchanged for UE registration with delegated network slice admission control by an SCP. Referring to the message flow in FIG. 6, UE 114 sends a UE registration request to AMF 110. In step 1, AMF 110 sends an Nudm_UECM_Registration request including the 3gpp-Sbi-Correlation-Info header that identifies network slices to SCP 101. In step 2, SCP 101 sends the Nudm_UECM_Registration request message with the 3gpp-Sbi-Correlation-Info header to UDM 104. In step 3, UDM 104 responds with an Nudm_UECM_Registration response message including the 3gpp-Sbi-Correlation-Info header. SCP 101 invokes delegated slice admission control using the SUPI and slice info received in the 3gpp-Sbi-Correlation-Info header from the registration request. In step 4, SCP 101 sends a Nnsacf_NSAC_NumOfUEsUpdate_Request message to NSACF 132. In step 5, NSACF 132 responds with a Nnsacf_NSAC_NumOfUEsUpdate_Response message that indicates, for each network slice identified in the request, whether access is granted or denied. SCP 101 adds, to the 3gpp-Sbi-Correlation-Info header in the Nudm_UECM_Registration response message, the identifiers for the admitted network slices from the response received from the NSACF. In step 6, SCP 101 sends the Nudm_UECM_Registration response message including the 3gpp-Sbi-Correlation-Info header to AMF 110. AMF 110 sends a registration accept message to UE 114 with identifiers for the admitted network slices as received in the 3gpp-Sbi-Correlation-Info header from the Nudm_UECM_Registration response message. Thus, the message flow illustrated in FIG. 6 with delegated network slice admission control achieves the UE registration with network slice admission control with six message hops in the core network versus eight message hops in the message flow illustrated in FIG. 4.

The NSACF controls the number of PDU sessions per network slice by incrementing/decrementing the PDU session count per network slice during PDU session establishment and PDU session release procedures. Upon receiving the Nsmf_PDUSession_CreateSMContext request message from the AMF, the SCP initiates delegated network slice admission control by sending the Nnsacf_NSAC_NumOfPDUsUpdate_Request message towards the NSACF. The SCP has a configurable option to perform the network slice availability check and update with the NSACF. The NSACF performs the availability check, and, if the PDU session count exceeds the configured allowed maximum PDU session threshold for a given network slice, responds with error response. If the PDU session count does not exceed the threshold, the NSACF increments the PDU session count and responds with a 200 success response. Upon receiving the 200 success response, the SCP proceeds with routing the PDU session establishment request towards the SMF or performs SMF selection in case of model D delegated Nsmf_PDUSession_CreateSMContext SBI service request. In the case of an error response, the SCP rejects the Nsmf_PDUSession_CreateSMContext request from the AMF with an error response with configured error status code.

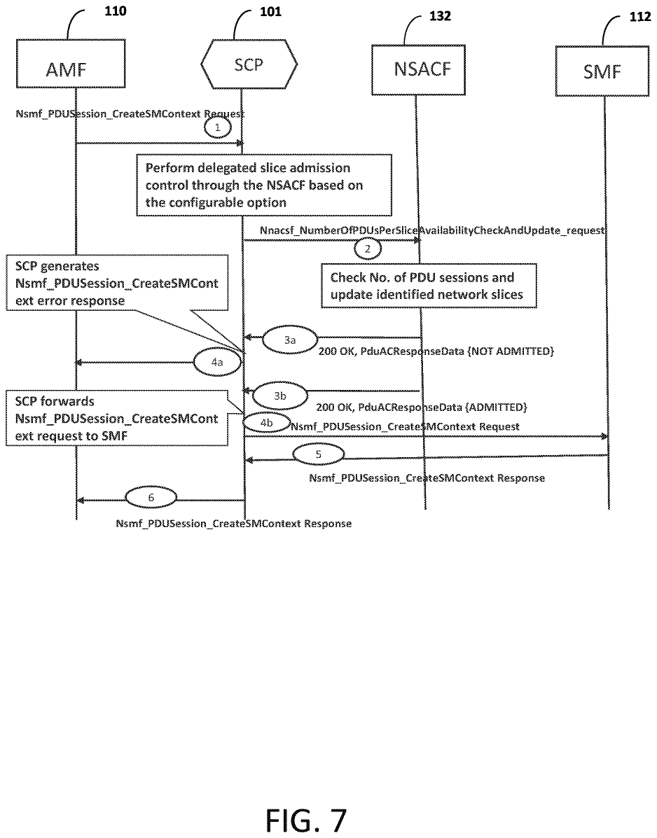

FIG. 7 is a message flow diagram illustrating exemplary messages exchanged for PDU session establishment with delegated network slice admission control by an SCP. Referring to FIG. 7, In step 1, AMF 110 sends Nsmf_PDUSession_CreateSMContext request message to SCP 101. SCP 101 performs delegated network slice admission control by sending a Nnsacf_NSAC_NumOfPDUsUpdate_Request message to NSACF 132. NSACF 132 performs a check of the number of PDU sessions for each network slice identified in the request and responds as indicated in step 3a or 3b indicating whether PDU sessions are admitted to use the network slices or not admitted to use the network slices. If the result of the network slice availability check is an error indicating that the PDU sessions are not admitted, SCP 101 responds as indicated in step 4a with an error response to AMF 110. If the response from the NSACF is a success response indicating that the PDU sessions are admitted, SCP 101 forwards the Nsmf_PDUSession_CreateSMContext request message to SMF 108, as indicated in step 4b. In step 5, SMF 108 responds with a Nsmf_PDUSession_CreateSMContext response message. In step 6, SCP 101 forwards the Nsmf_PDUSession_CreateSMContext response message to AMF 110. Thus, as indicated in FIG. 7, six message hops are required to perform delegated network slice admission control in response to a PDU session creation request versus eight message hops required in FIG. 5. In addition, AMF 110 is not required to implement the Nnsacf interface.

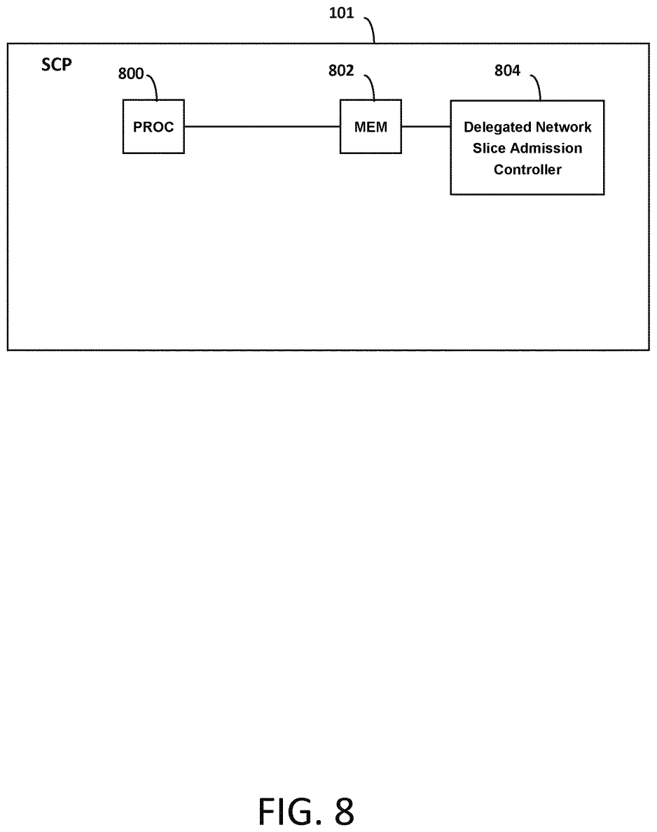

FIG. 8 is a block diagram illustrating an exemplary SCP for performing delegated network slice admission control for UE registration and PDU session establishment procedures. Referring to FIG. 6, SCP 101 includes at least one processor 800 and memory 802. SCP 101 includes a delegated network slice admission controller 804 that performs the steps described herein for delegated network slice admission control illustrated in FIGS. 6 and 7. Delegated network slice admission controller 804 may be implemented using computer executable instructions stored in memory 802 and executed by processor 800.

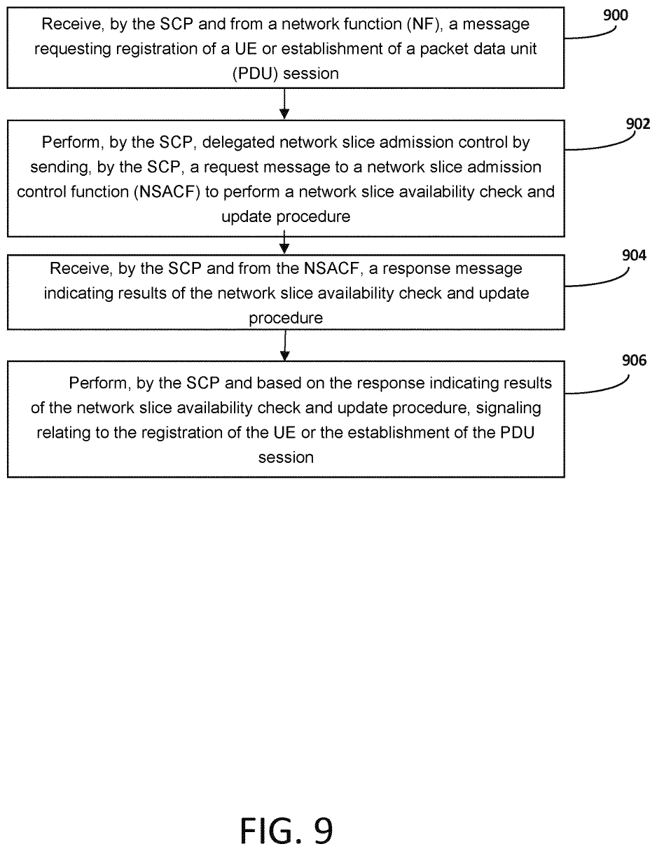

FIG. 9 is a flow chart illustrating an exemplary process for delegated network slice admission control by an SCP for UE registration and PDU session establishment procedures. Referring to FIG. 9, in step 900, the process includes receiving, by the SCP and from a network function (NF), a message relating to registration of a UE or establishment of a PDU session. For example, SCP 101 may receive an Nudm_UECM_Registration_Response message from a UDM or an Nsmf_PDUSession_CreateSMContext request message from an AMF.

In step 902, the process includes performing, by the SCP, delegated network slice admission control by sending, by the SCP, a request message to a network slice admission control function (NSACF) to perform a network slice availability check and update procedure. For example, if the received message is an Nudm_UECM_Registration_Response message, the SCP may hold the response and generate and send Nnsacf_NSAC_NumOfUEsUpdate_Request message to the NSACF. The SCP may include, in the Nnsacf_NSAC_NumOfUEsUpdate_Request message, the NSSAIs of network slices for which registration is requested. If the received message is an Nsmf_PDUSession_CreateSMContext request message, the SCP may generate and send an Nnsacf_NSAC_NumOfPDUsUpdate_Request message to the NSACF

In step 904, the process includes receiving, by the SCP and from the NSACF, a response message indicating results of the network slice availability check and update procedure. For example, if the SCP transmitted an Nnsacf_NSAC_NumOfUEsUpdate_Request message in step 902, the SCP may receive an Nnsacf_NSAC_NumOfUEsUpdate_Response message from the NSACF. If the SCP transmitted an Nnsacf_NSAC_NumOfPDUsUpdate_Request message in step 902, the SCP may receive an Nnsacf_NSAC_NumOfPDUsUpdate_Response message from the NSACF.

In step 906, the process includes performing, by the SCP and based on the response indicating results of the network slice availability check and update procedure, signaling relating to the registration of the UE or the establishment of the PDU session. For example, if the SCP received an Nnsacf_NSAC_NumOfUEsUpdate_Response message in step 904, the SCP may update the Nudm_UECM_Registration_Response message received in step 900 to include the NSSAIs of the network slices to which admission is granted and forward the Nudm_UECM_Registration_Response message to the AMF. If the SCP received an Nnsacf_NSAC_NumOfPDUsUpdate_Response message in step 904, the SCP may add the NSSAIs of the network slices to which admission is granted to the Nsmf_PDUSession_CreateSMContext request message received in step 900 and forward the Nsmf_PDUSession_CreateSMContext request message to the SMF.

While the examples described above relate to performing delegated network slice admission control for UE registration and PDU session establishment, the subject matter described herein is not limited to using the SCP to facilitate communication with the NSACF only for the UE registration and PDU session establishment call flows. The SCP described herein may also communicate with the NSACF on behalf of an NF that does not support the Nnsacf interface for UE deregistration and PDU session termination call flows.

Exemplary advantages of the subject matter described herein include reduced numbers of message hops for the UE registration and PDU session establishment. Another advantage of the subject matter described herein is the avoidance of upgrading each NF, such as the AMF and SMF, to implement the Nnsacf interface. Another advantage of the subject matter described herein is increased capacity and efficiency at both the AMF and the SMF by offloading the processing required for slice admission control functionality. Yet another advantage of the subject matter described herein is providing support for network slice admission control functionality with R16 compliant NFs.

The disclosure of each of the following references is incorporated herein by reference in its entirety.

### REFERENCES

1. 3^{rd} Generation Partnership Project; Technical Specification Group Core Network and Terminals; 5G System; Network Function Repository Services; Stage 3 (Release 19) 3GPP TS 29.510 V19.4.0 (2025-09)
2. 3^{rd} Generation Partnership Project; Technical Specification Group Services and System Aspects for the 5G System (5GS); Stage 2 (Release 20) 3GPP TS 23.501 V20.0.0 (2025-12)
3. 3^{rd} Generation Partnership Project; Technical Specification Group Core Services and System Aspects; Procedures for the 5G System; Stage 2 (Release 19) 3GPP TS 23.502 V19.6.0 (2025-12)

It will be understood that various details of the subject matter described herein may be changed without departing from the scope of the subject matter described herein. Furthermore, the foregoing description is for the purpose of illustration only, and not for the purpose of limitation, as the subject matter described herein is defined by the claims as set forth hereinafter.

What is claimed is:

1. A method for delegated network slice admission control using a service communication proxy (SCP), the method comprising:
receiving, by the SCP and from a network function (NF), a message relating to registration of a user equipment (UE) or establishment of a packet data unit (PDU) session;
performing, by the SCP, delegated network slice admission control by:
sending, by the SCP, a request message to a network slice admission control function (NSACF) to perform a network slice availability check and update procedure; and
receiving, by the SCP and from the NSACF, a response message indicating results of the network slice availability check and update procedure; and
performing, by the SCP and based on the response indicating results of the network slice availability check and update procedure, signaling relating to the registration of the UE or the establishment of the PDU session.

2. The method of claim 1 wherein receiving the message relating to the registration of the UE or establishment of the PDU session includes receiving an Nudm_UECM_Registration_Response message from a unified data management function (UDM) and directed towards an access and mobility management function (AMF) and further comprising, holding, by the SCP, the Nudm_UECM_Registration_Response message while the SCP performs the delegated network slice admission control.

3. The method of claim 2 wherein sending the request message to the NSACF includes sending, by the SCP, an Nnsacf_NSAC_NumOfUEsUpdate_Request message to the NSACF.

4. The method of claim 3 wherein receiving the response message from the NSACF includes receiving, from the NSACF, an Nnsacf_NSAC_NumOfUEsUpdate_Response message including a result indication per network slice selection availability information (NSSAI) as to whether a maximum number of UEs has been reached for a network slice identified by the NSSAI.

5. The method of claim 4 comprising adding, by the SCP, the result indications per NSSAI to the Nudm_UECM_Registration_Response message and wherein performing, by the SCP and based on the response indicating results of the network slice availability check and update procedure, signaling relating to the registration of the UE or the establishment of the PDU session includes forwarding, by the SCP and to the AMF, the Nudm_UECM_Registration response message including the result indications per NSSAI.

6. The method of claim 1 wherein receiving the message relating to registration of the UE or establishment of the PDU session includes receiving an Nsmf_PDUSession_CreateSMContext request message from an access and mobility management function (AMF).

7. The method of claim 6 wherein sending the request message to the NSACF includes sending, by the SCP, an Nnsacf_NSAC_NumOfPDUsUpdate_Request message to the NSACF.

8. The method of claim 7 wherein receiving the response message from the NSACF includes receiving, from the NSACF, an Nnsacf_NSAC_NumOfPDUsUpdate_Response message including a result indication per network slice selection availability information (NSSAI) as to whether a maximum number of PDU sessions has been reached for a network slice identified by the NSSAI.

9. The method of claim 8 wherein performing, by the SCP and based on the response indicating results of the network slice availability check and update procedure, signaling relating to the registration of the UE or the establishment of the PDU session includes:
sending the Nsmf_PDUSession_CreateSMContext request message to a session management function (SMF); and
including, in the Nsmf_PDUSession_CreateSMContext request message, NSSAIs of network slices to which admission is granted by the NSACF.

10. The method of claim 9 comprising receiving, by the SCP and from the SMF, a Nsmf_PDUSession_CreateSMContext response message and forwarding the Nsmf_PDUSession_CreateSMContext response message to the AMF.

11. A system for delegated network slice admission control using a service communication proxy (SCP), the system comprising:
an SCP including at least one processor and a memory;
a delegated network slice admission controller implemented by the at least one processor for:
receiving, from a network function (NF), a message relating to registration of a user equipment (UE) or establishment of a packet data unit (PDU) session; and
performing delegated network slice admission control by:
sending a request message to a network slice admission control function (NSACF) to perform a network slice availability check and update procedure; and
receiving, from the NSACF, a response message indicating results of the network slice availability check and update procedure; and
performing, based on the response indicating results of the network slice availability check and update procedure, signaling relating to the registration of the UE or the establishment of the PDU session.

12. The system of claim 11 wherein the message relating to registration of the UE or establishment of the PDU session includes an Nudm_UECM_Registration_Response message from a unified data management function (UDM) and directed towards an access and mobility management function (AMF) and wherein the delegated network slice admission controller is configured to hold the Nudm_UECM_Registration_Response message while the SCP performs the delegated network slice admission control.

13. The system of claim 12 wherein the request message sent to the NSACF comprises an Nnsacf_NSAC_NumOfUEsUpdate_Request message.

14. The system of claim 13 wherein the response message received from the NSACF comprises an Nnsacf_NSAC_NumOfUEsUpdate_Response message including a result indication per network slice selection availability information (NSSAI) as to whether a maximum number of UEs has been reached for a network slice identified by the NSSAI.

15. The system of claim 14 wherein the delegated network slice admission controller is configured to add the result indications per NSSAI to the Nudm_UECM_Registration_Response message and to perform the signaling relating to the registration of the UE or the establishment of the PDU session by forwarding, to the AMF, the Nudm_UECM_Registration response message including the result indications per NSSAI.

16. The system of claim 11 the message relating to registration of a UE or establishment of a PDU session includes an Nsmf_PDUSession_CreateSMContext request message from an access and mobility management function (AMF).

17. The system of claim 16 wherein the request message sent to the NSACF includes an Nnsacf_NSAC_NumOfPDUsUpdate_Request message.

18. The system of claim 17 wherein the response message received from the NSACF includes an Nnsacf_NSAC_NumOfPDUsUpdate_Response message including a result indication per network slice selection availability information (NSSAI) as to whether a maximum number of PDU sessions has been reached for a network slice identified by the NSSAI.

19. The system of claim 18 wherein the delegated network slice admission controller is configured to perform the signaling relating to the registration of the UE or the establishment of the PDU session by:
sending the Nsmf_PDUSession_CreateSMContext request message to a session management function (SMF);
including, in the Nsmf_PDUSession_CreateSMContext request message, NSSAIs of network slices to which admission is granted by the NSACF; and
receiving, by the SCP and from the SMF, a Nsmf_PDUSession_CreateSMContext response message and forwarding the Nsmf_PDUSession_CreateSMContext response message to the AMF.

20. A non-transitory computer readable medium having stored thereon executable instructions that when executed by a processor of a computer control the computer to perform steps comprising:
receiving, by a service communication proxy (SCP) and from a network function (NF), a message relating to registration of a user equipment (UE) or establishment of a packet data unit (PDU) session;
performing, by the SCP, delegated network slice admission control by:
sending, by the SCP, a request message to a network slice admission control function (NSACF) to perform a network slice availability check and update procedure; and
receiving, by the SCP and from the NSACF, a response message indicating results of the network slice availability check and update procedure; and
performing, by the SCP and based on the response indicating results of the network slice availability check and update procedure, signaling relating to the registration of the UE or the establishment of the PDU session.
